(19) United States
(12) Patent Application Publication
(10) Pub. No.: US 2025/0071564 A1
(43) Pub. Date: Feb. 27, 2025

(54) METHODS AND APPARATUSES THEREOF FOR SHARING A CHANNEL OCCUPANCY TIME (COT) OF A FRAME BASED EQUIPMENT (FBE)

(71) Applicants: Beijing Xiaomi Mobile Software Co., Ltd., Beijing (CN); BEIJING UNIVERSITY OF POSTS AND TELECOMMUNICATIONS, Beijing (CN)

(72) Inventors: Yajun ZHU, Beijing (CN); Wei HONG, Beijing (CN); Yiyi LU, Beijing (CN); Yong LI, Beijing (CN)

(73) Assignees: Beijing Xiaomi Mobile Software Co., Ltd., Beijing (CN); BEIJING UNIVERSITY OF POSTS AND TELECOMMUNICATIONS, Beijing (CN)

(21) Appl. No.: 18/725,974

(22) PCT Filed: Dec. 31, 2021
(86) PCT No.: PCT/CN2021/143969

§ 371 Date: Jul. 1, 2024

(51) Int. Cl. H04W 16/14; H04L 5/00; H04W 72/0446

(52) U.S. Cl. CPC H04W 16/14; H04L 5/0091; H04W 72/0446

(57) ABSTRACT

Embodiments of the present application provide methods and apparatuses for sharing a channel occupancy time (COT) of a frame-based equipment (FBE). One of the methods includes sending, to a network device, indication information of a fixed frame period (FFP) during which a currently enabled COT is located, wherein the indication information at least comprises parameter information of the FFP.

### CROSS REFERENCE

The present application is a national phase application of International Application No. PCT/CN2021/143969, filed on Dec. 31, 2021, and the entire contents thereof are incorporated herein by reference.

### TECHNICAL FIELD

The present disclosure relates to the field of communication technology, and in particular to a method and device for sharing a channel occupancy time COT of a frame based equipment.

### BACKGROUND

In the channel access mode of frame based equipment (FBE), the terminal equipment (UE) can currently start the channel occupancy time (COT) autonomously, share the remaining COT with the next generation Node B (gNB) after uplink transmission, and share the COT with other UEs for uplink transmission through the gNB downlink transmission to improve the channel access efficiency of FBE.

It should be noted that, information disclosed in the above background portion is provided only for better understanding of the background of the present disclosure, and thus it may contain information that does not form the prior art known by those ordinary skilled in the art.

### SUMMARY

The embodiments of the present application provides methods and devices for sharing the channel occupancy time (COT) of a frame based equipment (FBE).

In a first aspect, an embodiment of the present application provides a method for sharing the COT of the FBE. The method is performed by a first terminal device and includes: sending indication information of the first terminal device for indicating a fixed frame period (FFP) during which a currently enabled COT is located to a network device, wherein the indication information includes at least parameter information of the FFP.

In a second aspect, an embodiment of the present application provides a method for sharing the COT of the FBE. The method is executed by a network device and includes: receiving indication information sent by a first terminal device, wherein the indication information includes at least parameter information of the FFP during which the currently enabled COT of the first terminal device is located; and sending the indication information to at least one second terminal device.

In a third aspect, an embodiment of the present application provides a method for sharing the COT of the FBE. The method is executed by a second terminal device and includes: obtaining indication information sent by a network device, wherein the indication information includes at least parameter information of the FFP during which the currently enabled COT of the first terminal device is located; and based on the indication information, performing uplink transmission within a shared COT segment of the currently enabled COT.

In a fourth aspect, an embodiment of the present application provides a communication device, which has some or all of the functions of the first terminal device in the method described in the first aspect above. For example, the functions of the communication device may have some or all of the functions in the embodiments of the present application, or may have the functions of implementing any one of the embodiments of the present application separately. The functions may be implemented by a hardware, or by a hardware executing a corresponding software. The hardware or software includes one or more units or modules corresponding to the above functions.

In a fifth aspect, an embodiment of the present application provides another communication device, which has some or all of the functions of the network device in the method example described in the second aspect above. For example, the functions of the communication device may have some or all of the functions in the embodiments of the present application, or may have the functions of implementing any one of the embodiments of the present application separately. The functions may be implemented by a hardware, or by a hardware executing a corresponding software. The hardware or software includes one or more units or modules corresponding to the above functions.

In a sixth aspect, an embodiment of the present application provides another communication device, which has some or all of the functions of the second terminal device in the method example described in the third aspect above. For example, the functions of the communication device may have some or all of the functions in the embodiments of the present application, or may have the functions of implementing any one of the embodiments of the present application separately. The functions may be implemented by a hardware, or by a hardware executing a corresponding software. The hardware or software includes one or more units or modules corresponding to the above functions.

In a seventh aspect, an embodiment of the present application provides a communication device, which includes a processor. When the processor executes a computer program in a memory, the method described in the first aspect is executed.

In an eighth aspect, an embodiment of the present application provides a communication device, which includes a processor. When the processor executes a computer program in a memory, the method described in the second aspect is executed.

In a ninth aspect, an embodiment of the present application provides a communication device, which includes a processor. When the processor executes a computer program in a memory, the method described in the third aspect is executed.

In a tenth aspect, an embodiment of the present application provides a communication device, which includes a processor and a memory in which a computer program is stored. The processor executes the computer program stored in the memory so that the communication device executes the method described in the first aspect above.

In an eleventh aspect, an embodiment of the present application provides a communication device, which includes a processor and a memory in which a computer program is stored. The processor executes the computer program stored in the memory so that the communication device executes the method described in the second aspect above.

In a twelfth aspect, an embodiment of the present application provides a communication device, which includes a processor and a memory in which a computer program is stored. The processor executes the computer program stored in the memory so that the communication device executes the method described in the third aspect above.

In a thirteenth aspect, an embodiment of the present application provides a communication device, which includes a processor and an interface circuit, wherein the interface circuit is used to receive code instructions and transmit the code instructions to the processor, and the processor is used to run the code instructions to enable the device to execute the method described in the first aspect above.

In a fourteenth aspect, an embodiment of the present application provides a communication device, which includes a processor and an interface circuit, wherein the interface circuit is used to receive code instructions and transmit the code instructions to the processor, and the processor is used to run the code instructions to enable the device to execute the method described in the second aspect above.

In a fifteenth aspect, an embodiment of the present application provides a communication device, which includes a processor and an interface circuit, wherein the interface circuit is used to receive code instructions and transmit the code instructions to the processor, and the processor is used to run the code instructions to enable the device to execute the method described in the third aspect above.

In a sixteenth aspect, an embodiment of the present application provides a communication system. The system includes the communication device described in the fourth aspect, the communication device described in the fifth aspect, and the communication device described in the sixth aspect, or the system includes the communication device described in the seventh aspect, the communication device described in the eighth aspect, and the communication device described in the ninth aspect, or the system includes the communication device described in the tenth aspect, the communication device described in the eleventh aspect, and the communication device described in the twelfth aspect, or the system includes the communication device described in the thirteenth aspect, the communication device described in the fourteenth aspect, and the communication device described in the fifteenth aspect.

In a seventeenth aspect, an embodiment of the present application provides a non-transitory computer-readable storage medium for storing instructions for the above-mentioned first terminal device. When the instructions are executed, the first terminal device executes the method described in the first aspect.

In an eighteenth aspect, an embodiment of the present application provides a non-transitory computer-readable storage medium for storing instructions for the above-mentioned network device. When the instructions are executed, the network device executes the method described in the above-mentioned second aspect.

In a nineteenth aspect, an embodiment of the present application provides a non-transitory computer-readable storage medium for storing instructions for the above-mentioned second terminal device. When the instructions are executed, the second terminal device executes the method described in the third aspect.

In a twentieth aspect, the present application also provides a computer program product including a computer program, which, when executed on a computer, enables the computer to execute the method described in the first aspect above.

In a twenty-first aspect, the present application also provides a computer program product including a computer program, which, when executed on a computer, enables the computer to execute the method described in the second aspect above.

In a twenty-second aspect, the present application also provides a computer program product including a computer program, which, when executed on a computer, enables the computer to execute the method described in the third aspect above.

In a twenty-third aspect, the present application provides a chip system, which includes at least one processor and an interface, for supporting a terminal device to implement the functions involved in the first aspect, for example, determining or processing at least one of the data and information involved in the above method. In one example design, the chip system also includes a memory, which is used to store computer programs and data necessary for the terminal device. The chip system can include a chip, or can include a chip and discrete devices.

In a twenty-fourth aspect, the present application provides a chip system, which includes at least one processor and an interface, for supporting a network device to implement the functions involved in the second aspect, for example, determining or processing at least one of the data and information involved in the above method. In one example design, the chip system also includes a memory, which is used to store computer programs and data necessary for the network device. The chip system can include a chip, or can include a chip and discrete devices.

In a twenty-fifth aspect, the present application provides a chip system, which includes at least one processor and an interface, for supporting the second terminal device to implement the functions involved in the third aspect, for example, determining or processing at least one of the data and information involved in the above method. In one example design, the chip system also includes a memory, which is used to store computer programs and data necessary for the second terminal device. The chip system can include a chip, or can include a chip and discrete devices.

In a twenty-sixth aspect, the present application provides a computer program which, when executed on a computer, enables the computer to execute the method described in the first aspect above.

In a twenty-seventh aspect, the present application provides a computer program which, when executed on a computer, enables the computer to execute the method described in the second aspect above.

In a twenty-eighth aspect, the present application provides a computer program which, when executed on a computer, enables the computer to execute the method described in the third aspect above.

It is to be understood that both the foregoing general description and the following detailed description are exemplary and explanatory only and are not restrictive of the present disclosure.

### BRIEF DESCRIPTION OF THE DRAWINGS

In order to more clearly illustrate the technical solutions in the embodiments of the present application or the background technology, the drawings required for use in the embodiments of the present application or the background technology will be described below.

FIG. 1 is a schematic diagram of the FBE frame structure;

FIG. 2 is a schematic diagram of the architecture of a communication system provided in an embodiment of the present application;

FIG. 3 is a flow chart of a method for sharing a COT of an FBE provided in an embodiment of the present application;

FIG. 4 is a specific example of “FBE COT sharing between terminal devices using a network device as a connection point”;

FIG. 5 is a specific example of “FFP parameter confusion”;

FIG. 6 is a specific example of “unable to reclaim channel using right”;

FIG. 7 is a flow chart of a method for sharing a COT of an FBE provided in an embodiment of the present application;

FIG. 8 is a flow chart of a method for sharing a COT of an FBE provided in an embodiment of the present application;

FIG. 9 is a flow chart of a method for sharing a COT of an FBE provided in an embodiment of the present application;

FIG. 10 is a flow chart of a method for sharing a COT of an FBE provided in an embodiment of the present application;

FIG. 11 is a flow chart of a method for sharing a COT of an FBE provided in an embodiment of the present application;

FIG. 12 is a flow chart of a method for sharing a COT of an FBE provided in an embodiment of the present application;

FIG. 13 is a flow chart of a method for sharing a COT of an FBE provided in an embodiment of the present application;

FIG. 14 is a flow chart of a method for sharing a COT of an FBE provided in an embodiment of the present application;

FIG. 15 is a flow chart of a method for sharing a COT of an FBE provided in an embodiment of the present application;

FIG. 16 is a schematic structural diagram of a COT sharing device of an FBE provided in an embodiment of the present application;

FIG. 17 is a schematic diagram of the structure of a communication device provided in an embodiment of the present application; and

FIG. 18 is a schematic diagram of the structure of a chip provided in an embodiment of the present application.

### DETAILED DESCRIPTION

Exemplary embodiments will be described in detail herein, examples of which are shown in the accompanying drawings. When the following description refers to the drawings, unless otherwise indicated, the same numbers in different drawings represent the same or similar elements. The implementations described in the following exemplary embodiments do not represent all implementations consistent with the present application. Instead, they are merely examples of devices and methods consistent with some aspects of the present application as detailed in the appended claims.

To facilitate understanding, the terms involved in this application are first introduced.

### 1. Frame Based Equipment (FBE)

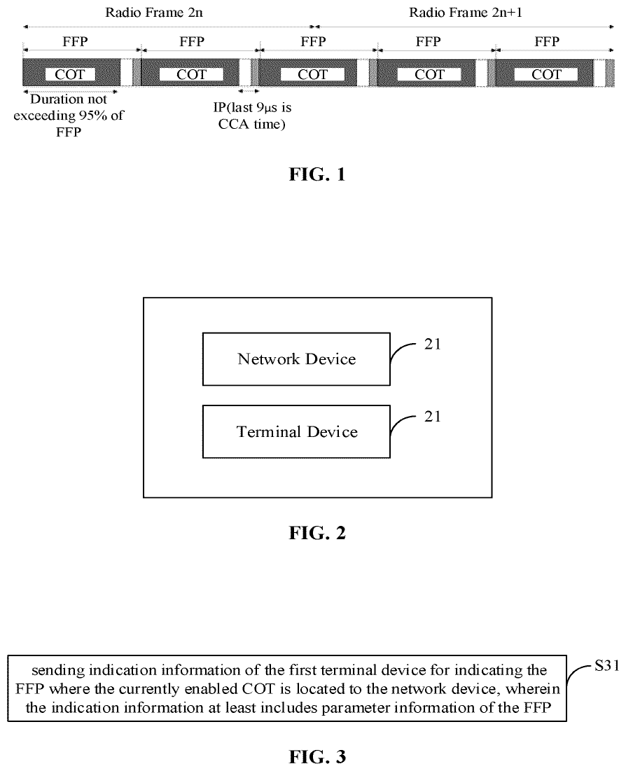

FBE is a listen before talk (LBT) channel access mode with a fixed frame structure. FIG. 1 is a schematic diagram of the FBE frame structure, which includes multiple fixed frame periods FFP.

### 2. Fixed Frame Period (FFP)

FFP is a component of the FBE frame structure. As shown in FIG. 1, FFP includes the channel occupancy time COT and the idle period (IP). The last 9 μs of the idle period is the time for the node to perform clear channel assessment (CCA). The length of FFP can be configured to 1˜10 ms. The configuration value must be maintained and cannot be changed within 200 ms. The length of COT in one FFP cannot exceed 95% of the length of FFP. The length of IP is Max {5%·FFP, 100 μs}.

### 3. Channel Occupancy Time (COT)

When CCA determines that the channel is idle, the terminal device or network device can enable the COT and transmit data within the COT.

In order to better understand the method for sharing the channel occupancy time COT of a frame based equipment FBE disclosed in an embodiment of the present application, the communication system to which the embodiment of the present application is applicable is first described below.

Please refer to FIG. 2, which is a schematic diagram of the architecture of a communication system provided in an embodiment of the present application. The communication system may include, but is not limited to, a network device and a terminal device. The number and form of devices shown in FIG. 2 are only used as examples and do not constitute a limitation on the embodiments of the present application. In actual applications, two or more network devices and two or more terminal devices may be included. The communication system shown in FIG. 2 takes a network device 21 and a terminal device 22 as an example.

It should be noted that the technical solutions of the embodiments of the present application can be applied to various communication systems, such as long term evolution (LTE) system, fifth generation (5G) mobile communication system, 5G new radio (NR) system, or other future new mobile communication systems.

The network device 21 in the embodiment of the present application is an entity on the network side for transmitting or receiving signals. For example, the network device 21 may be an evolved NodeB (eNB), a transmission reception point (TRP), a next generation NodeB (gNB) in an NR system, a base station in other future mobile communication systems, or an access point in a wireless fidelity (WiFi) system. The embodiments of the present application do not limit the specific technology and specific device form adopted by the network device. The network device provided in the embodiment of the present application may include a central unit (CU) and a distributed unit (DU), wherein the CU may also be referred to as a control unit. The CU-DU structure may be used to split the protocol layer of the network device, such as a base station, and the functions of some protocol layers are placed in the CU for centralized control, and the functions of the remaining part or all of the protocol layers are distributed in the DU, and the DU is centrally controlled by the CU.

The terminal device 22 in the embodiment of the present application is an entity for receiving or transmitting signals on the user side, such as a mobile phone. The terminal device may also be referred to as a terminal device (terminal), a user equipment (UE), a mobile station (MS), a mobile terminal device (MT), etc. The terminal device may be a car with communication function, a smart car, a mobile phone, an Internet of Things device such as NB-IoT or (e) MTC, a wearable device, a tablet computer (Pad), a computer with wireless transceiver function, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiment of the present application does not limit the specific technology and specific device form adopted by the terminal device.

It can be understood that the communication system described in the embodiment of the present application is for more clearly illustrating the technical solution of the embodiment of the present application, and does not constitute a limitation on the technical solution provided in the embodiment of the present application. Those of ordinary skill in the art can know that with the evolution of the system architecture and the emergence of new service scenarios, the technical solution provided in the embodiment of the present application is also applicable to similar technical problems.

It can be understood that the multiple schemes in the embodiments of the present application can be implemented separately or in combination, and the present application does not limit this.

Hereinafter, the method and device for sharing the channel occupancy time COT of the frame based equipment FBE provided in the present application are explained in detail in conjunction with the accompanying drawings.

FIG. 3 is a flow chart of a method for sharing a COT of an FBE according to an embodiment of the present application. The method is applied to a first terminal device. As shown in FIG. 3, the method includes:

S31, sending indication information of the first terminal device for indicating the FFP where the currently enabled COT is located to the network device, wherein the indication information at least includes parameter information of the FFP.

In the related art, the terminal device can autonomously enable the FBE COT and share the FBE COT autonomously enabled by the terminal device with the network device. Based on this feature, a new COT sharing method can be generated, namely “FBE COT sharing between terminal devices with the network device as the connection point”.

The FBE COT refers to the channel occupancy time determined by the terminal after the channel detection performed by the terminal through FBE is passed.

In the embodiment of the present application, the first terminal device (UE 1) autonomously enables the FBE COT, and after performing uplink transmission in the COT, the remaining COT can be shared with the network device. The network device performs downlink transmission on the shared COT. After detecting the downlink transmission, the second terminal device (UE 2) will mistakenly believe that it is the COT enabled by the network device and then share the COT enabled by the first terminal device for uplink transmission.

It should be noted that the first terminal device is a terminal device that autonomously enables the COT, and the second terminal device is a terminal device that shares the COT enabled by the first terminal device. There is at least one second terminal device.

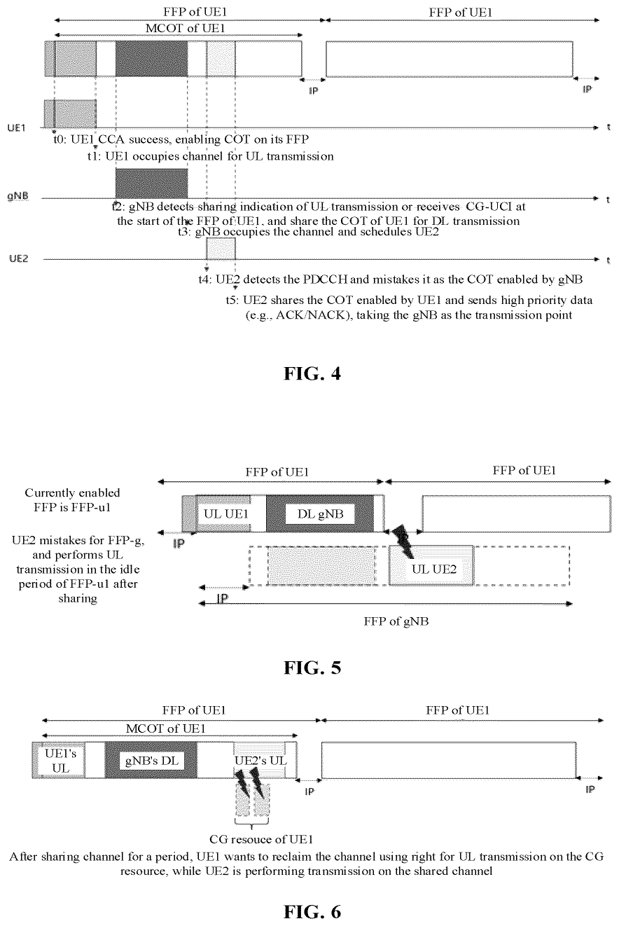

FIG. 4 below shows a specific example, where UE2 shares the COT enabled by UE1 (gNB as the connection point) and completes the transmission of high-priority data traffic within UE1's COT without waiting for the next FFP, thus reducing the waiting delay. However, this new sharing method will cause problems such as “FFP parameter confusion” and “unable to reclaim channel using right”, making this sharing method unable to operate normally.

In the embodiment, the “FFP parameter confusion” means that when the first terminal device autonomously enables the COT, the FFP starting point position and duration of the first terminal device may be different from those of the network device. The second terminal device will mistakenly regard the COT enabled by the first terminal device as the COT enabled by the network device to use the shared COT, thereby causing FFP parameter confusion and mistakenly taking the activated FFP where the shared COT is located as the FFP of the network device. A specific example can be seen in FIG. 5.

The “unable to reclaim channel using right” means that when the first terminal device wants to reclaim the right to use the channel and perform uplink transmission again, the channel may still be used by the second terminal device, causing the first terminal device to be unable to use it. A specific example can be seen in FIG. 6.

In order to improve the above-mentioned COT sharing method, in an embodiment of the present application, after the first terminal device autonomously enables the COT, it sends the network device an indication information of the FFP where the currently enabled COT of the first terminal device is located. The indication information includes parameter information of the FFP, and optionally, the parameter information at least includes identification information of the FFP and/or sharing parameter of the currently enabled COT. The network device and the second terminal device can occupy the COT according to the FFP parameter information in the indication information, avoiding the problems of “FFP parameter confusion” and “unable to reclaim channel using right”.

Optionally, the identification information of FFP can be used to indicate that the FFP where the shared COT is located belongs to the first terminal device. The second terminal device can determine, based on the FFP identification, that the shared COT is the COT enabled by the first terminal device, rather than the COT enabled by the network device, thereby solving the problem of “FFP parameter confusion” through the FFP identification information.

Optionally, the sharing parameter includes the sharing start position of the COT and/or the sharing duration of the COT. It should be noted that the sharing start position is used to indicate the starting point of the COT of the first terminal device that is allowed to be shared, and the sharing duration is the length of time that the COT of the first terminal device is allowed to be shared.

Optionally, the parameter information of the FFP may also include the length of the FFP and the starting position of the FFP. The sharing parameter of the COT may also include the sharing end position of the COT. The sharing start position and the sharing duration may also determine the sharing end position, and the sharing end position and the sharing start position of the COT may determine the sharing duration.

In an embodiment of the present application, the sharing parameter can indicate a segment of the COT of the first terminal device that is allowed to be shared. The second terminal device and the network device need to share the COT segment allowed to be shared by the first terminal device based on the sharing parameter. The COT portion exceeding that indicated the sharing parameter will no longer be shared by the network device and the second terminal device, that is, the first terminal device can reclaim the right to use the channel, and the problem of “unable to reclaim channel using right” can be solved by the sharing parameter.

In some implementations, the indication information carrying the parameter information of FFP may be sent by the first terminal device to the network device separately through a signaling. In other implementations, the indication information carrying the parameter information of FFP may be sent by the first terminal device to the network device simultaneously through uplink transmission. For example, the first terminal device may send the indication information to the network device through Configure Grant Uplink Control Information (CG-UCI).

Optionally, the identification information of the FFP and the sharing parameter of the COT may be simultaneously carried in the indication information and sent to the network device, or the identification information of the FFP and the sharing parameter may be reported to the network device separately through respective indication information.

In an embodiment of the present application, the network device may send indication information to the second terminal device. The second terminal device may be one or more. Based on the FFP identification information, the network device and the second terminal device may determine that the shared COT is the COT enabled by the first terminal device, rather than the COT enabled by the network device, thereby solving the problem of “FFP parameter confusion” through the FFP identification information. The second terminal device and the network device need to share the COT segment allowed to be shared by the first terminal device based on the sharing parameter. The COT portion exceeding the sharing parameter will no longer be shared by the network device and the second terminal device, that is, the first terminal device can reclaim the right to use the channel, and then the problem of “unable to reclaim channel using right” can be solved through the sharing parameter.

An embodiment of the present application provides a method for sharing a COT of an FBE. By sending indication information of the FFP where the COT currently enabled by a first terminal device is located to a network device, the network device can indicate parameter information of the FFP to other terminal devices, so that the network device and the second terminal device sharing the COT of the first terminal device can occupy the COT shared by the first terminal device according to the parameter information of the FFP, which can solve the problems of “FFP parameter confusion” and “unable to reclaim channel using right”.

FIG. 7 is a flow chart of a method for sharing a COT of an FBE according to an embodiment of the present application. The method is applied to a first terminal device. As shown in FIG. 7, the method includes:

S71, determining the indication information used by the first terminal device to indicate the FFP where the currently enabled COT is located.

In an embodiment of the present application, the indication information includes parameter information of the FFP, wherein the parameter information of the FFP includes identification information of the FFP and/or sharing parameter of the currently enabled COT, and the COT sharing parameter includes the sharing start position of the COT and/or the sharing duration of the COT. Optionally, the sharing parameter of the COT may also include the sharing end position of the COT.

For an introduction to the parameter information of FFP, please refer to the relevant contents in the embodiments of the present application, which will not be repeated here.

S72, sending the indication information to the network device in the uplink transmission in the currently enabled COT.

After the first terminal device autonomously enables the COT, it can perform uplink transmission on the enabled COT. Optionally, the first terminal device performs CCA within the idle time IP of the FFP, and in response to the evaluation result of the CCA that the channel is idle, starts uplink transmission within the currently enabled COT, and sends indication information to the network device during the uplink transmission.

Optionally, the first terminal device may carry the indication information in uplink transmission to send the indication information to the network device.

As a possible implementation, the uplink transmission of the first terminal device may last for a period of time, and the indication information may be sent to the network device at any time during the uplink transmission. In some implementations, the first terminal device may send the indication information to the network device through uplink transmission at the start stage of the uplink transmission; in other implementations, the first terminal device may send the indication information to the network device through uplink transmission in the middle stage of the uplink transmission; in some other implementations, the first terminal may send the indication information to the network device through uplink transmission at the end stage of the uplink transmission. Optionally, the FFP identification information and the sharing parameter of COT included in the parameter information of FFP may be indicated to the network device together at the same stage of the uplink transmission, or may be indicated to the network device separately at different stages. For example, the identification information of FFP may be sent to the network device at the start stage or the middle stage of the uplink transmission, and the sharing parameter of COT may be sent to the network device at the end stage of the uplink transmission.

In the embodiment of the present application, the network device may send the indication information to the second terminal device. The second terminal device may be one or more. Based on the FFP identifier, the network device and the second terminal device may determine that the shared COT is the COT enabled by the first terminal device, rather than the COT enabled by the network device, thereby solving the problem of “FFP parameter confusion” through the FFP identifier information.

The second terminal device and the network device need to share the COT segment allowed to be shared by the first terminal device based on the sharing parameter. The COT portion exceeding the sharing parameter will no longer be shared by the network device and the second terminal device, that is, the first terminal device can reclaim the right to use the channel, and the problem of “unable to reclaim channel using right” can be solved by the sharing parameter.

The embodiment of the present application provides a method for sharing the COT of an FBE, further including the following steps:

Optionally, the indication information also includes a COT sharing indication, wherein the COT sharing indication is used to indicate whether the currently enabled COT is to be shared. If the first terminal device allows the currently enabled COT to be shared, the COT sharing indication indicates to the network device that the currently enabled COT can be shared. If the first terminal device does not allow the currently enabled COT to be shared, the COT sharing indication indicates to the network device that the currently enabled COT cannot be shared. Of course, it is also possible to determine according to a communication protocol or other means that the first terminal device does not allow the currently enabled COT to be shared by default, and to determine that the currently enabled COT is allowed to be shared unless the network device receives a clear indication. Of course, it is also possible to determine according to a communication protocol or other means that the first terminal device allows the currently enabled COT to be shared by default, and to determine that the currently enabled COT is not allowed to be shared unless the network device receives a clear indication.

Optionally, the network device may determine whether to send indication information to the second terminal device based on the COT sharing indication. In one embodiment, if it is determined that the first terminal device allows the currently enabled COT to be shared, the network device sends the indication information to the second terminal device. In one embodiment, if it is determined that the first terminal device does not allow the currently enabled COT to be shared, the network device will not send the indication information to the second terminal device.

The embodiment of the present application provides a method for sharing the COT of FBE, by determining the indication information of the FFP where the currently enabled COT of the first terminal device is located, the indication information can be sent to the network device in the uplink transmission in the currently enabled COT. In this way, the network device can determine the parameter information of the FFP and indicate it to other terminal devices, so that the network device and the second terminal device sharing the COT of the first terminal device can occupy the COT shared by the first terminal device according to the parameter information of the FFP, which can solve the problems of “FFP parameter confusion” and “unable to reclaim channel using right”.

FIG. 8 is a flow chart of a method for sharing a COT of an FBE according to an embodiment of the present application. The method is applied to a first terminal device. As shown in FIG. 8, the method includes:

S81, determining the COT segment remaining when the uplink transmission of the first terminal device ends as the shared COT segment.

After the first terminal device autonomously enables the COT, it can perform uplink transmission on the enabled COT. After the uplink transmission is completed, in order to improve the utilization rate of the channel, the remaining COT fragments can be used as shared COT fragments. The shared COT fragments can be shared with the network device for downlink transmission, and can also be shared with the second terminal device through the network device for uplink transmission. The second terminal device is a terminal device that shares the COT enabled by the first terminal device, and there is at least one second terminal device.

As a possible implementation, at the beginning of uplink transmission, based on the time domain resource occupancy of the uplink transmission, the COT segment that the first terminal device needs to occupy is determined, and then the remaining COT segment can be determined as the shared COT segment. As another possible implementation, at the end of uplink transmission, the subsequent COT that has not been used is determined as the remaining COT segment as the shared COT segment.

S82, determining a sharing parameter based on the format configuration information of the transmission time domain unit in the shared COT segment.

Optionally, the transmission time domain unit may be a time slot, or a symbol in a time slot, or any other time domain unit.

In an embodiment of the present application, the sharing parameter can be determined according to the format configuration information of the transmission time domain unit in the shared COT segment. Optionally, the format configuration information includes the uplink transmission time domain unit and the downlink transmission time domain unit, and based on the format configuration information, it is determined from which position the COT is shared and how long the sharing is, that is, the sharing start position of the COT and the sharing duration of the COT, and the sharing start position of the COT and/or the sharing duration of the COT are used as the sharing parameter of the COT.

In all embodiments of the present disclosure, the sharing parameter of the COT may include at least one of the following parameters: the sharing start position of the COT, the sharing end position of the COT, and the sharing duration of the COT. At the same time, the relevant parameters of the shared COT segment can be determined in combination with the sharing parameter of the COT and the communication standard or preset configuration. For example, in some implementations, the sharing start position of the COT is one or more of the following: the sharing start position of the network device, the sharing start position of the second terminal device.

Optionally, the first downlink transmission time domain unit in the remaining COT segment is used as the sharing starting position of the network device, which can instruct the network device to share the COT of the first terminal device at the starting position for downlink transmission; and the first uplink transmission time domain unit in the remaining COT segment is used as the sharing starting position of the second terminal device, which can instruct the second terminal device to share the COT of the first terminal device at the starting position for uplink transmission.

Correspondingly, the sharing starting position of the network device has the corresponding sharing duration of the network device, instructing the network device to perform downlink transmission within the specified sharing duration; and the sharing starting position of the second terminal device has the corresponding sharing duration of the second terminal device, instructing the second terminal device to perform uplink transmission within the specified sharing duration.

Optionally, the last downlink transmission time domain unit in the remaining COT segment is used as the sharing end position of the network device, and the sharing duration of the network device is determined based on the sharing start position and the sharing end position of the network device; and the last uplink transmission time domain unit in the remaining COT segment is used as the sharing end position of the second terminal device, and the sharing duration of the second terminal device is determined based on the sharing start position and the sharing end position of the second terminal device. Optionally, in order to ensure that the first terminal device can perform uplink transmission in a timely manner, some of the subsequent uplink transmission time domain units can be reserved, that is, the reserved uplink transmission time domain units are not allowed to be shared.

In all embodiments of the present disclosure, a default method (such as a communication protocol or pre-configuration) can be used to determine the sharing start position and/or sharing end position. For example: if the time domain unit is a symbol, the first symbol in the remaining COT segment can be used as the sharing start position of the network device's downlink transmission by default; if the time domain unit is a slot, the first symbol of the first slot in the remaining COT segment can be used as the sharing start position of the network device's downlink transmission by default. Similarly, the sharing start position of the second terminal device can also be a default position. At the same time, the sharing start position of the downlink transmission of the network device and the sharing start position of the second terminal device are not limited in any order. For example, the downlink transmission of the network device can be performed first, and then the transmission of the second terminal device can be performed: or other orders can be used. The sharing start position of the downlink transmission of the network device and the sharing start position of the second terminal device can be either an absolute position or a relative position relative to the remaining COT segment. For example, if the downlink transmission of the network device is performed first, a default relative position after the end of the downlink transmission of the network device can be used as the sharing start position of the second terminal device. For another example, if the shared transmission of the second terminal device is performed first, a default relative position after the end can be used as the sharing start position of the downlink transmission of the network device. For another example, the absolute positions of the downlink transmission of the network device and the shared transmission of the second terminal device may be predetermined in the remaining COT segment.

S83: generating a sharing configuration table based on the COT sharing indication and the parameter information of the FFP, and using the sharing configuration table as indication information.

Obtain the COT sharing indication and the parameter information of the FFP, i.e., including the identification information of the FFP and the sharing parameter of the COT, generate a sharing configuration table, and use the sharing configuration table as the indication information. For the detailed explanation of the COT sharing indication and the parameter information of the FFP, please refer to the relevant description in the embodiments of the present application, which will not be repeated here.

It should be noted that in FBE mode, the first terminal device can configure a high-level parameter and send a sharing configuration table to the network device through the high-level parameter. In the embodiment, the sharing configuration table may include multiple rows, and each row may optionally correspond to parameter information of a type of FFP. Optionally, the first row is the sharing starting position of the COT, for example, it can be expressed as X+O, where X is the time slot offset and O is the symbol offset, that is, shared transmission is allowed from X+O. The second row is the sharing duration of the COT, which can be a symbol-level duration: the third row is the identification information of the FFP where the currently enabled COT of the first terminal device is located, and optionally it can also include the starting position of the FFP, the length of the FFP, etc.; and the fourth row is the COT sharing indication.

S84, sending the instruction information to the network device.

Regarding the implementation method of step S84, any implementation method in the embodiments of the present application may be adopted and will not be described in detail here.

In the embodiment of the present application, the network device may send the indication information to the second terminal device. The second terminal device may be one or more. Based on the FFP identifier, the network device and the second terminal device may determine that the shared COT is the COT enabled by the first terminal device, rather than the COT enabled by the network device, thereby solving the problem of “FFP parameter confusion” through the FFP identifier information.

The second terminal device and the network device need to share the COT segment allowed to be shared by the first terminal device based on the sharing parameter. The COT portion exceeding the sharing parameter will no longer be shared by the network device and the second terminal device, that is, the first terminal device can reclaim the right to use the channel, and the problem of “unable to reclaim channel using right” can be solved by sharing parameter.

The embodiment of the present application provides a method for sharing the COT of FBE, which determines the COT fragment remaining at the end of the uplink transmission of the first terminal device as a shared COT fragment, determines the sharing parameter based on the format configuration information of the transmission time domain unit in the shared COT fragment, generates a sharing configuration table based on the COT sharing indication and the identification information of the FFP, uses the sharing configuration table as the indication information, and sends the indication information to the network device. In this way, the identification information of the FFP, the sharing parameter of the COT, and the COT sharing indication can be sent to the network device together, wherein the COT sharing indication and the sharing parameter of the COT can indicate whether to share the currently enabled COT and the time when the sharing can be performed, so as to avoid the second terminal device from occupying the COT of the first terminal device all the time, resulting in the first terminal device being unable to reclaim the channel using right. In addition, through the identification information of the FFP, the FFP parameter confusion can be avoided, so that the second terminal device no longer mistakenly regards the shared COT as the COT enabled by the network device.

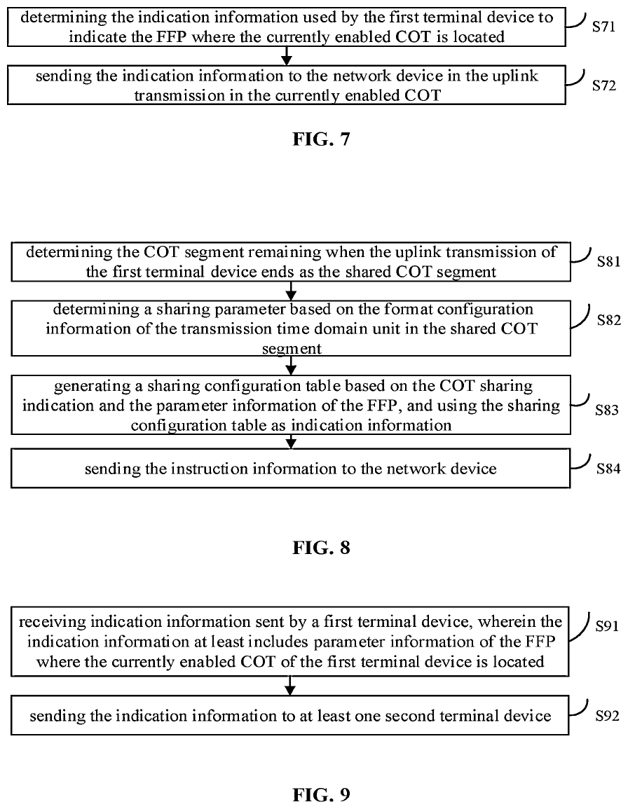

FIG. 9 is a flow chart of a method for sharing a COT of an FBE according to an embodiment of the present application. The method is applied to a network device. As shown in FIG. 9, the method includes:

S91, receiving indication information sent by a first terminal device, wherein the indication information at least includes parameter information of the FFP where the currently enabled COT of the first terminal device is located.

In an embodiment of the present application, the indication information includes parameter information of the FFP, wherein the parameter information of the FFP includes identification information of the FFP and/or sharing parameter of the currently enabled COT, and the COT sharing parameter includes the sharing start position of the COT and/or the sharing duration of the COT. Optionally, the sharing parameter of the COT may also include the sharing end position of the COT. For an explanation of the parameter information of the FFP, please refer to the relevant contents in any embodiment of the present application, which will not be repeated here.

Optionally, indication information sent by the first terminal device is received through uplink transmission; or indication information sent by the first terminal device is received through a signaling.

In some implementations, the indication information carrying the parameter information of FFP may be sent by the first terminal device to the network device separately through a signaling. In other implementations, the indication information carrying the parameter information of FFP may be sent by the first terminal device to the network device simultaneously through uplink transmission. For example, the first terminal device may send the indication information to the network device through CG-UCI.

Optionally, the identification information of FFP and the sharing parameter of COT can be simultaneously carried in the indication information and sent to the network device, or the identification information of FFP and the sharing parameter of COT can be reported to the network device through their respective indication information. Correspondingly, the network device can receive the indication information carrying both the identification information of FFP and the sharing parameter of COT, or can receive one indication information carrying the identification information of FFP and another indication information carrying the sharing parameter of COT.

Optionally, the network device may receive a sharing configuration table, which includes the indication information, namely, identification information of the FFP and sharing parameter of the COT. It should be noted that in FBE mode, the first terminal device may configure a high-level parameter and send the sharing configuration table to the network device through the high-level parameter. In the embodiment, the sharing configuration table may include multiple rows, and each row may correspond to parameter information of a type of FFP. Optionally, the first row is the sharing starting position of the COT, for example, it can be expressed as X+O, where X is the time slot offset and O is the symbol offset, that is, shared transmission is allowed from X+O. The second row is the sharing duration of the COT, which can be a symbol-level duration: the third row is the identification information of the FFP where the currently enabled COT of the first terminal device is located, and optionally it may also include the starting position of the FFP, the length of the FFP, etc.; and the fourth row is the COT sharing indication.

S92: sending the indication information to at least one second terminal device.

In some implementations, the network device may schedule at least one second terminal device in the COT of the first terminal device to perform uplink transmission, and send indication information to the scheduled second terminal device to increase the utilization rate of the COT of the first terminal device.

In some other implementations, the network device broadcasts the indication information during downlink transmission to notify the scheduled second terminal device of the indication information of the first terminal device.

In the embodiment of the present application, the network device may send the indication information to the second terminal device. The second terminal device may be one or more. Based on the FFP identifier, the network device and the second terminal device may determine that the shared COT is the COT enabled by the first terminal device, rather than the COT enabled by the network device, thereby solving the problem of “FFP parameter confusion” through the FFP identifier information.

The second terminal device and the network device need to share the COT segment allowed to be shared by the first terminal device based on the sharing parameter. The COT portion exceeding the sharing parameter will no longer be shared by the network device and the second terminal device, that is, the first terminal device can reclaim the right to use the channel, and the problem of “unable to reclaim channel using right” can be solved by sharing parameter.

The embodiment of the present application provides a method for sharing the COT of an FBE, further including the following steps:

Optionally, the indication information further includes a COT sharing indication, wherein the COT sharing indication is used to indicate related operations for sharing the currently enabled COT. If the first terminal device allows the currently enabled COT to be shared, the COT sharing indication indicates to the network device that the currently enabled COT can be shared. If the first terminal device does not allow the currently enabled COT to be shared, the COT sharing indication indicates to the network device that the currently enabled COT cannot be shared. Of course, as mentioned above, the scheme of default setting of on/off can be adopted, and the default setting can be overridden through explicit action.

Optionally, the network device may determine whether to send indication information to the second terminal device based on the COT sharing indication. If it is determined that the first terminal device allows the currently enabled COT to be shared, the network device sends the indication information to the second terminal device. If it is determined that the first terminal device does not allow the currently enabled COT to be shared, the network device does not send the indication information to the second terminal device.

An embodiment of the present application provides a method for sharing a COT of an FBE, which receives indication information sent by a first terminal device, and indicates parameter information of an FFP where a COT currently enabled by the first terminal device is located to at least one second terminal device, so that a network device and a second terminal device sharing the COT of the first terminal device can occupy the COT shared by the first terminal device according to the parameter information of the FFP, thereby solving the problems of “FFP parameter confusion” and “unable to reclaim channel using right”.

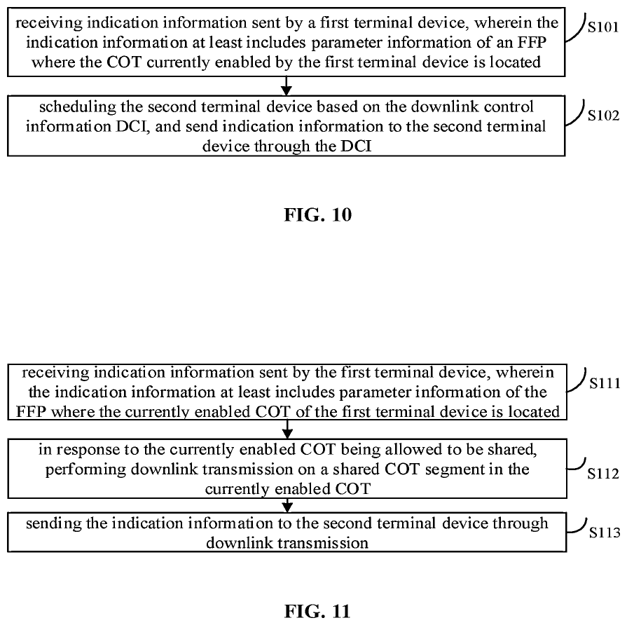

FIG. 10 is a flow chart of a method for sharing a COT of an FBE according to an embodiment of the present application. The method is applied to a network device. As shown in FIG. 10, the method includes:

S101, receiving indication information sent by a first terminal device, wherein the indication information at least includes parameter information of an FFP where the COT currently enabled by the first terminal device is located.

Indication information sent by the first terminal device is received through uplink transmission, wherein the indication information at least includes parameter information of the FFP where the currently enabled COT of the first terminal device is located. Optionally, the parameter information at least includes identification information of the FFP and/or sharing parameter of the currently enabled COT, wherein the sharing parameter includes the sharing start position of the COT and/or the sharing duration of the COT. Optionally, the indication information also includes a COT sharing indication for indicating whether to share the currently enabled COT.

For specific contents of the FFP identification information and the COT sharing parameter included in the parameter information of the FFP, reference may be made to the relevant introduction in each embodiment of the present disclosure, which will not be repeated here.

S102: scheduling the second terminal device based on the downlink control information DCI, and send indication information to the second terminal device through the DCI.

When the network device wants to schedule a specific second terminal device to share the COT, it can send a DCI to the scheduled second terminal device on a physical downlink control channel (PDCCH), and send the indication information to the second terminal device through the DCI.

Optionally, the indication information further includes a COT sharing indication, wherein the COT sharing indication is used to indicate whether the currently enabled COT is shared. If the first terminal device allows the currently enabled COT to be shared, the COT sharing indication indicates to the network device that the currently enabled COT can be shared. If the first terminal device does not allow the currently enabled COT to be shared, the COT sharing indication indicates to the network device that the currently enabled COT cannot be shared.

In an embodiment of the present application, before sending the indication information to the second terminal device, the network device can determine whether to send the indication information to the second terminal device based on the COT sharing indication. If the COT sharing indication indicates that the first terminal device allows the currently enabled COT to be shared, the network device sends the indication information to the second terminal device. If the COT sharing indication indicates that the first terminal device does not allow the currently enabled COT to be shared, the network device will not send the indication information to the second terminal device. An embodiment of the present application provides a method for sharing the COT of FBE, the indication information sent by the first terminal device is received, wherein the indication information at least includes the parameter information of the FFP where the currently enabled COT of the first terminal device is located, and the indication information may be sent to the scheduled second terminal device through DCI to instruct the second terminal device to share the COT shared by the first terminal device according to the FFP parameters, so that the network device and the second terminal device that share the COT of the first terminal device can occupy the COT shared by the first terminal device according to the FFP parameter information, which can solve the problems of “FFP parameter confusion” and “unable to reclaim channel using right”.

FIG. 11 is a flow chart of a method for sharing a COT of an FBE according to an embodiment of the present application. The method is applied to a network device. As shown in FIG. 11, the method includes:

S111, receiving indication information sent by the first terminal device, wherein the indication information at least includes parameter information of the FFP where the currently enabled COT of the first terminal device is located.

Regarding the implementation method of step S111, any implementation method in the embodiments of the present application can be adopted and will not be described in detail here.

S112: in response to the currently enabled COT being allowed to be shared, performing downlink transmission on a shared COT segment in the currently enabled COT.

Optionally, the indication information further includes a COT sharing indication, wherein the COT sharing indication is used to indicate whether the currently enabled COT is shared. If the first terminal device allows the currently enabled COT to be shared, the COT sharing indication indicates to the network device that the currently enabled COT can be shared. If the first terminal device does not allow the currently enabled COT to be shared, the COT sharing indication indicates to the network device that the currently enabled COT cannot be shared.

According to the COT sharing indication, it is determined that the currently enabled COT is allowed to be shared, and the network device can start downlink transmission from the sharing start position on the shared COT segment. In some implementations, the network device starts downlink transmission from the sharing start position of the COT and completes the downlink transmission within the sharing duration of the COT. In other implementations, the sharing start position of the COT includes the sharing start position of the network device and the sharing start position of the second terminal device, and the sharing duration of the COT includes the sharing duration of the COT of the network device and the sharing duration of the COT of the second terminal device. The network device can start downlink transmission from the sharing start position corresponding to the network device, and complete the downlink transmission within the sharing duration corresponding to the COT of the network device.

S113: sending the indication information to the second terminal device through downlink transmission.

The network device may broadcast indication information when performing downlink transmission, and send the indication information to all second terminal devices that detect the downlink transmission.

As a possible implementation, the downlink transmission of the network device may last for a period of time, and the indication information may be sent to the second terminal device at any time during the downlink transmission. In some implementations, the network device may send the indication information to the network device through downlink transmission at the start stage of the downlink transmission: in other implementations, the network device may send the indication information to the second device through downlink transmission at the middle stage of the downlink transmission: in some other implementations, the network device may send the indication information to the second terminal device through downlink transmission at the end stage of the downlink transmission. Optionally, the FFP identification information and the sharing parameter of COT included in the parameter information of FFP may be indicated to the second terminal device together at the same stage of the downlink transmission, or may be indicated to the second terminal device separately at different stages. For example, the identification information of FFP may be sent to the network device at the start stage or the middle stage of the downlink transmission, and the sharing parameter of COT may be sent to the network device at the end stage of the downlink transmission.

The embodiment of the present application provides a method for sharing a COT of an FBE. In this way, it is possible to determine whether the currently enabled COT is allowed to be shared according to the indication information. When it is allowed to be shared, the indication message is broadcast to the second terminal device through downlink transmission.

Thereby, the network device and the second terminal device sharing the COT of the first terminal device can occupy the COT shared by the first terminal device according to the parameter information of FFP, thereby solving the problems of “FFP parameter confusion” and “unable to reclaim channel using right”.

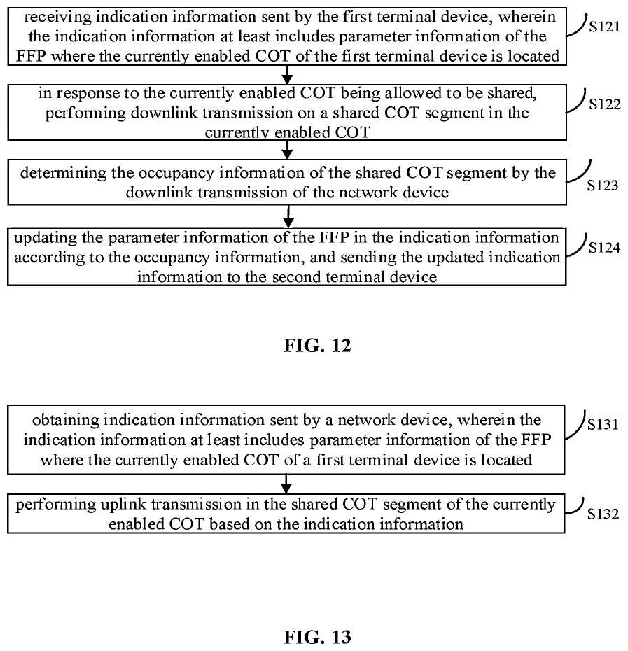

FIG. 12 is a flow chart of a method for sharing a COT of an FBE according to an embodiment of the present application. The method is applied to a network device. As shown in FIG. 12, the method includes:

S121, receiving indication information sent by the first terminal device, wherein the indication information at least includes parameter information of the FFP where the currently enabled COT of the first terminal device is located.

Regarding the implementation method of step S121, any implementation method in the embodiments of the present application can be adopted and will not be repeated in detail here.

S122: in response to the currently enabled COT being allowed to be shared, performing downlink transmission on a shared COT segment in the currently enabled COT.

Regarding the implementation method of step S122, any implementation method in the embodiments of the present application can be adopted and will not be repeated in detail here.

S123, determining the occupancy information of the shared COT segment by the downlink transmission of the network device.

When a network device needs to perform downlink transmission, it will share part or all of the COT segment. Optionally, the COT segment occupied by the network device at the end of the downlink transmission is determined. As a possible implementation, at the beginning of the downlink transmission, the COT segment occupied by the network device is determined based on the time domain resource occupancy of the downlink transmission. As another possible implementation, at the end of the downlink transmission, the COT segment occupied by the network device is determined.

The occupancy information of the shared COT segment by the network device may include the occupancy duration of the shared COT segment by the network device and/or the occupied transmission time domain unit.

S124, updating the parameter information of the FFP in the indication information according to the occupancy information, and sending the updated indication information to the second terminal device.

At this time, the remaining shared COT segment does not match the sharing parameter indicated in the indication information. In order to ensure that the second terminal device accurately occupies the remaining shared COT segment, the network device can update the indication information based on the occupancy time.

In some implementations, the sharing duration in the sharing parameter of the COT can be updated according to the occupied duration of the occupancy information, and the difference between the sharing duration and the occupied duration is used as the updated sharing duration. In some implementations, the sharing starting position in the sharing parameter of the COT can be re-determined and updated according to the occupied transmission time domain unit in the occupancy information to obtain an updated sharing starting position. Based on the updated sharing duration and the updated sharing starting position, the updated COT sharing parameter is determined. The indication information is updated based on the updated COT sharing parameter, and the updated indication information is sent to the second terminal device.

For example, if the downlink transmission of the network device exactly occupies the entire shared COT segment, the updated sharing duration is 0, indicating that the second terminal device cannot share and the channel is returned to the first terminal device. If the downlink transmission of the network device exceeds the shared COT segment, the network device immediately stops the downlink transmission after exceeding the shared COT segment, and the updated sharing duration is 0, indicating that the second terminal device cannot share and the channel is returned to the first terminal device. If the downlink transmission of the network device does not occupy the entire shared COT segment, the updated sharing duration is determined based on the difference between the sharing duration and the occupied duration, and the updated sharing starting position is determined based on the occupied transmission time domain unit in the occupancy information, indicating that the second terminal device performs uplink transmission at the updated sharing duration and sharing starting position.

An embodiment of the present application provides a method for sharing the COT of FBE. In this way, it can be determined whether the currently enabled COT is allowed to be shared based on the indication information. When it is allowed to be shared, the indication message is broadcast to the second terminal device through downlink transmission, and based on the occupancy of the shared COT by the network device, the indication information is updated, so that the second terminal device can perform uplink transmission according to the updated indication information, so that the second terminal can accurately determine the starting sharing position and sharing duration, and better perform uplink transmission on the remaining shared COT fragments.

FIG. 13 is a flow chart of a method for sharing a COT of an FBE according to an embodiment of the present application. The method is applied to a second terminal device. As shown in FIG. 13, the method includes:

S131, obtaining indication information sent by a network device, wherein the indication information at least includes parameter information of the FFP where the currently enabled COT of a first terminal device is located.

In an embodiment of the present application, the indication information includes parameter information of the FFP, wherein the parameter information of the FFP includes identification information of the FFP and/or sharing parameter of the currently enabled COT, and the COT sharing parameter includes the sharing start position of the COT and/or the sharing duration of the COT. Optionally, the sharing parameter of the COT may also include the sharing end position of the COT.

For specific contents of the FFP identification information and the COT sharing parameter included in the parameter information of the FFP, reference may be made to the relevant introduction in each embodiment of the present disclosure, which will not be repeated here.

In some implementations, the network device can schedule at least one second terminal device in the COT of the first terminal device for uplink transmission, and send indication information to the scheduled second terminal device to increase the utilization rate of the COT of the first terminal device. Accordingly, the second terminal device can receive the indication information.

In some other implementations, the network device broadcasts the indication information during downlink transmission to notify the scheduled second terminal device of the indication information of the first terminal device, and accordingly, the second terminal device can receive the indication information.

S132: performing uplink transmission in the shared COT segment of the currently enabled COT based on the indication information.

Based on the indication information, the second terminal device performs uplink transmission from the sharing starting position of the COT and completes the uplink transmission within the sharing duration of the COT.

In some implementations, the network device does not occupy the COT for downlink transmission, and the second terminal device starts uplink transmission from the sharing starting position of the COT and completes the uplink transmission within the sharing duration of the COT.

In some other implementations, the sharing starting position of the COT includes the sharing starting position of the network device and the sharing starting position of the second terminal device, and the sharing duration of the COT includes the sharing duration of the COT of the network device and the sharing duration of the COT of the second terminal device. The second terminal device starts uplink transmission from the sharing starting position of the second terminal device and completes the uplink transmission within the sharing duration of the COT of the second terminal device.

In some other implementations, after the network device performs downlink transmission in the shared COT, it updates the sharing start position and sharing duration in the indication information. The second terminal device starts uplink transmission at the updated sharing start position and completes the uplink transmission within the updated sharing duration.

In the embodiment of the present application, the second terminal device can determine, based on the FFP identifier, that the shared COT is the COT enabled by the first terminal device, rather than the COT enabled by the network device, thereby solving the problem of “FFP parameter confusion” through the FFP identifier information.

The second terminal device needs to share the COT segment allowed to be shared by the first terminal device based on the sharing parameter. The COT portion exceeding the sharing parameter will no longer be shared by the network device and the second terminal device. That is, the first terminal device can take back the right to use the channel, and the problem of “unable to reclaim channel using right” can be solved by sharing parameter.

The embodiment of the present application provides a method for sharing the COT of FBE, by obtaining the parameter information of the FFP in the indication information sent by the network device, the uplink transmission is performed in the shared COT segment of the currently enabled COT based on the indication information. The second terminal device can perform uplink transmission on the COT segment shared by the first terminal device according to the parameter information of the indicated FFP, and based on the identification information of the FFP, it can be determined that the FFP where the shared COT segment is located belongs to the first terminal device, not the network device, which can solve the “FFP parameter confusion”. Moreover, according to the sharing parameter of the COT, it can be avoided that the second terminal device occupies the COT of the first terminal device all the time, so that the first terminal device can timely reclaim the right to use the channel, solving the problem of “unable to reclaim channel using right”.

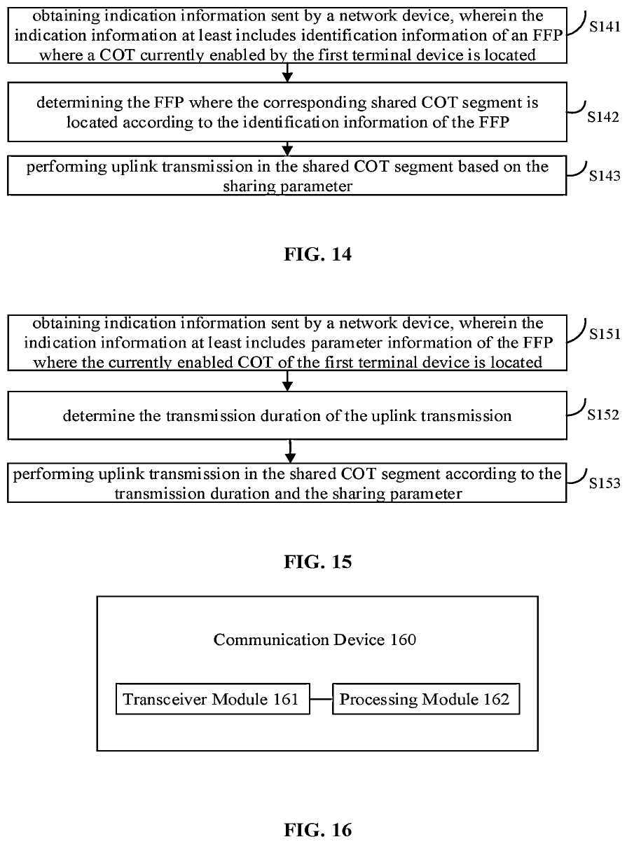

FIG. 14 is a flow chart of a method for sharing a COT of an FBE according to an embodiment of the present application. The method is applied to a second terminal device. As shown in FIG. 14, the method includes:

S141, obtaining indication information sent by a network device, wherein the indication information at least includes identification information of an FFP where a COT currently enabled by the first terminal device is located.

Regarding the implementation method of step S141, any implementation method in the embodiments of the present application can be adopted and will not be repeated here.

S142: determining the FFP where the corresponding shared COT segment is located according to the identification information of the FFP.

After the second terminal device receives the indication information, it can determine that the FFP where the currently enabled shared COT is located is the FFP corresponding to the communication device based on the identification information of the FFP in the indication information, thereby avoiding the problem of misjudgment. For example, if the identification information of the FFP in the indication information is 01, it is determined that the FFP where the shared COT is located is the FFP corresponding to the first terminal device UE1, that is, the first terminal device UE1 autonomously enables and shares the COT.

S143: performing uplink transmission in the shared COT segment based on the sharing parameter.

In some implementations, the network device does not occupy the COT for downlink transmission, and the second terminal device starts uplink transmission from the sharing starting position of the COT and completes the uplink transmission within the sharing duration of the COT.

In some other implementations, the sharing starting position of the COT includes the sharing starting position of the network device and the sharing starting position of the second terminal device, and the sharing duration of the COT includes the sharing duration of the COT of the network device and the sharing duration of the COT of the second terminal device. The second terminal device starts uplink transmission from the sharing starting position of the second terminal device and completes the uplink transmission within the sharing duration of the COT of the second terminal device.

In some other implementations, after the network device performs downlink transmission in the shared COT, the sharing start position and sharing duration in the indication information are updated. The second terminal device starts uplink transmission at the updated sharing start position and completes the uplink transmission within the updated sharing duration.

The embodiment of the present application provides a method for sharing the COT of FBE. In this way, it can be determined based on the identification information of FFP that the FFP where the shared COT segment is located belongs to the first terminal device, not the network device, and the “FFP parameter confusion” can be solved. Also, according to the sharing parameter of COT, it can be avoided that the second terminal device occupies the COT of the first terminal device all the time, so that the first terminal device can reclaim the channel using right in time, solving the problem of “unable to reclaim channel using right”.

FIG. 15 is a flow chart of a method for sharing a COT of an FBE according to an embodiment of the present application. The method is applied to a second terminal device. As shown in FIG. 15, the method includes:

S151, obtaining indication information sent by a network device, wherein the indication information at least includes parameter information of the FFP where the currently enabled COT of the first terminal device is located.

Regarding the implementation method of step S151, any implementation method in the embodiments of the present application can be adopted and will not be repeated here.

S152, determine the transmission duration of the uplink transmission of the second terminal device.

Optionally, the transmission duration of the uplink transmission is determined based on the time domain resource occupancy of the uplink transmission.

S153: performing uplink transmission in the shared COT segment according to the transmission duration and the sharing parameter.

In response to the transmission duration being less than or equal to the sharing duration of the COT in the sharing parameter, the uplink transmission is performed within the shared COT segment starting from the shared position of the COT in the sharing parameter.

In response to the transmission duration being greater than the sharing duration of COT in the sharing parameter, starting from the shared position of COT in the sharing parameter, uplink transmission is performed within the shared COT segment, and the uplink transmission is interrupted when the sharing duration of COT is reached; or in response to the transmission duration being greater than the sharing duration of COT, it is determined not to share the shared COT segment.

The embodiment of the present application provides a method for sharing the COT of FBE. In this way, it can be determined based on the identification information of FFP that the FFP where the shared COT segment is located belongs to the first terminal device, not the network device, and the “FFP parameter confusion” can be solved. Also, according to the sharing parameter of COT, it can be avoided that the second terminal device occupies the COT of the first terminal device all the time, so that the first terminal device can reclaim the channel using right in time, solving the problem of “unable to reclaim channel using right”.

In the embodiments provided by the present application, the methods provided by the embodiments of the present application are introduced from the perspectives of network device and terminal equipment, respectively. In order to implement the functions in the methods provided by the embodiments of the present application, the network device and the terminal device may include a hardware structure and a software module, and the functions may be implemented in the form of hardware structure, software module, or hardware structure plus software module. A certain function in the functions may be executed in the form of hardware structure, software module, or hardware structure plus software module.

Please refer to FIG. 16, which is a schematic diagram of the structure of a communication device 160 provided in an embodiment of the present application. The communication device 160 shown in FIG. 16 may include a transceiver module 161 and a processing module 162. The transceiver module 161 may include a transmitting module and a receiving module, the transmitting module is used to implement the transmitting function, the receiving module is used to implement the receiving function, and the transceiver module 161 can implement the transmitting function and the receiving function.

The communication device 160 may be a terminal device, a device in a terminal device, or a device that can be used in conjunction with a terminal device. Alternatively, the communication device 160 may be a network device, a device in a network device, or a device that can be used in conjunction with a network device.

The communication device 160 is a terminal device, including:
a transceiver module 161, configured to send indication information of the first terminal device for indicating the fixed frame period FFP where the currently enabled COT is located to the network device, wherein the indication information at least includes parameter information of the FFP.

Optionally, the indication information further includes a COT sharing indication, where the COT sharing indication is used to indicate whether to share the currently enabled COT.

Optionally, the parameter information includes at least identification information of the FFP and/or sharing parameter of the currently enabled COT.

Optionally, the transceiver module 161 is further configured to: send indication information to the network device in uplink transmission in the currently enabled COT.

Optionally, the communication device 160 further includes a processing module 162, configured to determine the COT segment remaining at the end of the uplink transmission of the first terminal device as a shared COT segment; and determine the sharing parameter based on the format configuration information of the transmission time domain unit in the shared COT segment.

Optionally, the sharing parameter includes a sharing starting position of the COT and/or a sharing duration of the COT.

Optionally, the processing module 162 is further configured to generate a sharing configuration table based on the COT sharing indication and the identification information of the FFP, and use the sharing configuration table as the indication information.

The communication device 160 is a network device, including:
a transceiver module 161, configured to receive indication information sent by a first terminal device, wherein the indication information at least includes parameter information of the FFP where the currently enabled COT of the first terminal device is located; and send the indication information to at least one second terminal device.

Optionally, the indication information further includes a COT sharing indication, where the COT sharing indication is used to indicate whether to share the currently enabled COT.

Optionally, the transceiver module 161 is further used to: determine that the currently enabled COT is allowed to be shared according to the COT sharing indication, and send indication information to the second terminal device.

Optionally, the parameter information includes at least identification information of the FFP and/or sharing parameter of the currently enabled COT.

Optionally, the sharing parameter includes a sharing starting position of the COT and/or a sharing duration of the COT.

Optionally, the transceiver module 161 is further configured to: schedule the second terminal device based on the downlink control information DCI, and send the indication information to the second terminal device through the DCI.

Optionally, the transceiver module 161 is further configured to: in response to the currently enabled COT being allowed to be shared, perform downlink transmission on the shared COT segment in the currently enabled COT; and/or send the indication information to the second terminal device through the downlink transmission.

Optionally, the communication device 160 further includes a processing module 162, configured to determine the occupancy information of the shared COT segment by the downlink transmission of the network device: update the parameter information of the FFP in the indication information according to the occupancy information, and send the updated indication information to the second terminal device.

The communication device 160 is a second terminal device, including:
a transceiver module 161, configured to: obtain indication information sent by the network device, wherein the indication information at least includes parameter information of the FFP where the currently enabled COT of the first terminal device is located; and based on the indication information, perform uplink transmission in the shared COT segment of the currently enabled COT.

Optionally, the parameter information includes at least identification information of the FFP and/or sharing parameter of the currently enabled COT.

Optionally, the sharing parameter includes a sharing starting position of the COT and/or a sharing duration of the COT.

Optionally, the transceiver module 161 is further configured to: receive DCI for scheduling the second terminal device, wherein the DCI carries indication information.

Optionally, the communication device 160 further includes a processing module 162, configured to detect downlink transmission sent by the network device, wherein the downlink transmission carries indication information.

Optionally, the processing module 162 is further configured to: determine, according to identification information of the FFP, the FFP where the corresponding shared COT segment is located; and perform uplink transmission in the shared COT segment based on the sharing parameter.

Optionally, the processing module 162 is further configured to: determine a transmission duration of the uplink transmission; and perform uplink transmission within a shared COT segment according to the transmission duration and the sharing parameter.

Optionally, the processing module 162 is further configured to: in response to the transmission duration being less than or equal to the sharing duration of the COT in the sharing parameter, perform uplink transmission within the shared COT segment starting from the sharing position of the COT in the sharing parameter.

Optionally, the processing module 162 is further configured to: in response to the transmission duration being greater than the sharing duration of COT in the sharing parameter, perform uplink transmission within the shared COT segment starting from the sharing position of COT in the sharing parameter, and interrupt the uplink transmission when the sharing duration of COT is reached; or, in response to the transmission duration being greater than the sharing duration of COT, determine not to share the shared COT segment.

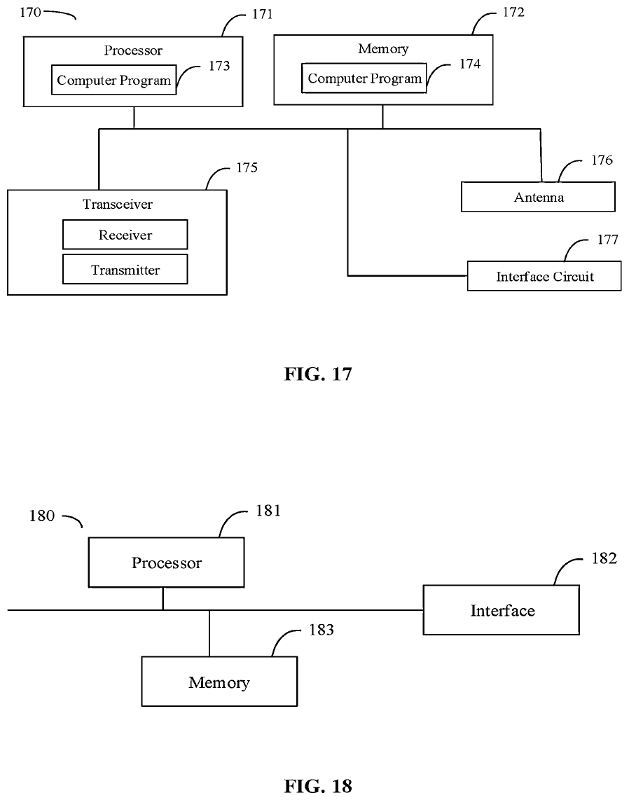

Please refer to FIG. 17, which is a schematic structural diagram of another communication device 170 provided by an embodiment of the present disclosure. The communication device 170 may be a network device, or may be a terminal device, or may be a chip, a chip system, a processor or the like that supports the network device to implement the above method, or may be a chip, a chip system, a processor or the like that supports the terminal device to implement the above method. The device can be used to implement the method described in the above method embodiments. For details, reference may be made to the description in the above method embodiments.

The communication device 170 may include one or more processors 171. The processor 171 may be a general-purpose processor or a dedicated processor, or the like. For example, the processor 171 may be a baseband processor or a central processing unit. The baseband processor can be used to process communication protocols and communication data. The central processor can be used to control the communication devices (such as base stations, baseband chips, terminal devices, terminal device chips, DU or CU, or the like), execute computer programs, and process data for the computer programs.

Optionally, the communication device 170 may also include one or more memories 172, on which a computer program 174 may be stored. The processor 171 executes the computer program 174, so that the communication device 170 performs the method described in the above method embodiments. Optionally, the memory 172 may also store data. The communication device 170 and the memory 172 can be provided separately or integrated together.

Optionally, the communication device 170 may also include a transceiver 175 and an antenna 176. The transceiver 175 may be referred to as a transceiver unit, a transceiver, a transceiver circuit, or the like, and is used to implement transceiver functions. The transceiver 175 may include a receiver and a transmitter. The receiver may be referred to as a receiver or a receiving circuit, or the like, and is used to implement the receiving function; and the transmitter may be referred to as a transmitter, a transmitting circuit, or the like, and is used to implement the transmitting function.

Optionally, the communication device 170 may also include one or more interface circuits 177. The interface circuit 177 is used to receive code instructions and transmit the code instructions to the processor 171. The processor 171 executes the code instructions to cause the communication device 170 to perform the method described in the above method embodiments.

In one implementation, the processor 171 may include a transceiver for implementing receiving and transmitting functions. For example, the transceiver may be a transceiver circuit, an interface, or an interface circuit. The transceiver circuits, interfaces or interface circuits used to implement the receiving and transmitting functions can be separate or integrated together. The above-mentioned transceiver circuit, interface or interface circuit can be used for reading and writing codes/data, or the above-mentioned transceiver circuit, interface or interface circuit can be used for signal transmission or transfer.

In one implementation, the processor 171 may be stored with a computer program 173, and the computer program 173 is executed by the processor 171, causing the communication device 170 to perform the method described in the above method embodiments. The computer program 173 may be solidified in the processor 171, in which case the processor 171 may be implemented by hardware.

In one implementation, the communication device 170 may include a circuit, and the circuit may implement the functions of sending or receiving or communicating in the foregoing method embodiments. The processors and transceivers described in this disclosure may be implemented on an integrated circuit (IC), an analog IC, a radio frequency integrated circuit (RFIC), a mixed signal IC, an application specific integrated circuit (ASIC), a printed circuit boards (PCB), an electronic device, and the like. The processor and transceiver can also be manufactured using various IC process technologies, such as complementary metal oxide semiconductor (CMOS), N-type metal oxide semiconductor (nMetal-oxide-semiconductor, NMOS), P-type metal oxide semiconductor (positive channel metal oxide semiconductor, PMOS), bipolar junction transistor (BJT), bipolar CMOS (BiCMOS), silicon germanium (SiGe), gallium arsenide (GaAs), and the like.

The communication device described in the above embodiments may be a network device or a terminal device, but the scope of the communication device described in this disclosure is not limited thereto, and the structure of the communication device may not be limited by FIG. 17. The communication device may be a stand-alone device or may be part of a larger device. For example, the communication device may be:
(1) a stand-alone integrated circuit IC, or chip, or chip system or subsystem;
(2) a set of one or more ICs. Optionally, the IC set may also include storage components for storing data and computer programs;
(3) an ASIC, such as a modem;
(4) a module that can be embedded in another device;
(5) a receiver, a terminal device, an intelligent terminal device, a cellular phone, a wireless device, a handheld device, a mobile unit, a vehicle-mounted device, a network device, a cloud device, an artificial intelligence device, and the like;
(6) others, etc.

For the case where the communication device may be a chip or a chip system, reference may be made to the schematic structural diagram of the chip shown in FIG. 18. The chip shown in FIG. 18 includes a processor 181 and an interface 182. The processor 181 may include one or more processors, and the interface 182 may include multiple interfaces.

Optionally, the chip also includes a memory 183, which is used to store necessary computer programs and data.

Those skilled in the art can also understand that the various illustrative logical blocks and steps listed in the embodiments of the present disclosure can be implemented by electronic hardware, computer software, or a combination of both. Whether such functionality is implemented in hardware or software depends on the specific application and overall system design requirements. Those skilled in the art can use various methods to implement the described functions for each specific application, but such implementation should not be understood as exceeding the scope of protection of the embodiments of the present disclosure.

Embodiments of the present disclosure also provide a system for sharing the COT of the FBE. The system includes a communication device as a network device and a communication device as a terminal device in the embodiment of FIG. 16, or the system includes a communication device as a network device and a communication device as a terminal device in the embodiment of FIG. 17.

The present disclosure also provides a readable storage medium on which instructions are stored. When the instructions are executed by a computer, the functions of any of the above method embodiments are implemented.

The present disclosure also provides a computer program product, which, when been executed by a computer, implements the functions of any of the above method embodiments.

The embodiment of the present application provides a method and device for sharing the channel occupancy time COT of a frame based equipment FBE. By sending indication information of a first terminal device for indicating the FFP where the currently enabled COT is located to a network device, the network device can indicate parameter information of the FFP to other terminal devices, so that the network device and the second terminal device sharing the COT of the first terminal device can occupy the COT shared by the first terminal device according to the parameter information of the FFP, which can solve the problems of “FFP parameter confusion” and “unable to reclaim channel using right”.

In a first aspect, an embodiment of the present application provides a method for sharing the COT of FBE, performed by a first terminal device, and the method includes: sending indication information of the first terminal device for indicating a fixed frame period FFP where a currently enabled COT is located to a network device, wherein the indication information includes at least parameter information of the FFP.

The application embodiment provides a method for sharing the COT of the FBE. By sending indication information of the first terminal device for indicating the FFP where the currently enabled COT is located to the network device, the network device can indicate the parameter information of the FFP to other terminal devices, so that the network device and the second terminal device sharing the COT of the first terminal device can occupy the COT shared by the first terminal device according to the parameter information of the FFP, which can solve the problems of “FFP parameter confusion” and “unable to reclaim channel using right”.

In a second aspect, an embodiment of the present application provides a method for sharing the COT of the FBE, which is executed by a network device, and the method includes: receiving indication information sent by a first terminal device, wherein the indication information includes at least parameter information of the FFP where the currently enabled COT of the first terminal device is located; and sending the indication information to at least one second terminal device.

The application embodiment provides a method for sharing the COT of the FBE, receiving indication information sent by a first terminal device, and indicating to at least one second terminal device the parameter information of the FFP where the currently enabled COT of the first terminal device is located, so that the network device and the second terminal device sharing the COT of the first terminal device can occupy the COT shared by the first terminal device according to the parameter information of the FFP, which can solve the problems of “FFP parameter confusion” and “unable to reclaim channel using right”.

In a third aspect, an embodiment of the present application provides a method for sharing the COT of the FBE, which is executed by a second terminal device, and the method includes: obtaining indication information sent by a network device, wherein the indication information includes at least parameter information of the FFP where the currently enabled COT of the first terminal device is located; and based on the indication information, performing uplink transmission within a shared COT segment of the currently enabled COT.

The application embodiment provides a method for sharing the COT of the FBE, by obtaining the parameter information of the FFP in the indication information sent by the network device, and based on the indication information, performing uplink transmission in the shared COT segment of the currently enabled COT, the second terminal device can perform uplink transmission on the COT segment shared by the first terminal device according to the indicated parameter information of the FFP, and based on the identification information of the FFP, it can be determined that the FFP where the shared COT segment is located belongs to the first terminal device, not the network device, which can solve the problem of “FFP parameter confusion”. Moreover, according to the sharing parameter of the COT, it can prevent the second terminal device from constantly occupying the COT of the first terminal device, so that the first terminal device can recover the channel using right in time, solving the problem of “unable to reclaim channel using right”.

In a fourth aspect, an embodiment of the present application provides a communication device, which has some or all of the functions of the terminal device in the method described in the first aspect above. For example, the functions of the communication device may have some or all of the functions in the embodiments of the present application, or may have the functions of implementing any one of the embodiments of the present application separately. The functions may be implemented by hardware, or by hardware executing corresponding software. The hardware or software includes one or more units or modules corresponding to the above functions.

In one implementation, the structure of the communication device may include a transceiver module and a processing module, and the processing module is configured to support the communication device to perform the corresponding functions in the above method. The transceiver module is used to support communication between the communication device and other devices. The communication device may also include a storage module, which is coupled to the transceiver module and the processing module, and stores computer programs and data necessary for the communication device.

As an example, the processing module may be a processor, the transceiver module may be a transceiver or a communication interface, and the storage module may be a memory.

In a fifth aspect, an embodiment of the present application provides another communication device, which has some or all of the functions of the network device in the method example described in the second aspect above. For example, the functions of the communication device may have some or all of the functions in the embodiments of the present application, or may have the functions of implementing any one of the embodiments of the present application separately. The functions may be implemented by hardware, or by hardware executing corresponding software. The hardware or software includes one or more units or modules corresponding to the above functions.

In one implementation, the structure of the communication device may include a transceiver module and a processing module, and the processing module is configured to support the communication device to perform the corresponding functions in the above method. The transceiver module is used to support communication between the communication device and other devices. The communication device may also include a storage module, which is coupled to the transceiver module and the processing module, and stores computer programs and data necessary for the communication device.

As an example, the processing module may be a processor, the transceiver module may be a transceiver or a communication interface, and the storage module may be a memory.

In a sixth aspect, an embodiment of the present application provides another communication device, which has some or all of the functions of the second terminal device in the method example described in the third aspect above. For example, the functions of the communication device may have some or all of the functions in the embodiments of the present application, or may have the functions of implementing any one of the embodiments of the present application separately. The functions may be implemented by hardware, or by hardware executing corresponding software. The hardware or software includes one or more units or modules corresponding to the above functions.

In one implementation, the structure of the communication device may include a transceiver module and a processing module, and the processing module is configured to support the communication device to perform the corresponding functions in the above method. The transceiver module is used to support communication between the communication device and other devices. The communication device may also include a storage module, which is coupled to the transceiver module and the processing module, and stores computer programs and data necessary for the communication device.

As an example, the processing module may be a processor, the transceiver module may be a transceiver or a communication interface, and the storage module may be a memory.

In a seventh aspect, an embodiment of the present application provides a communication device, which includes a processor. When the processor executes a computer program in a memory, the method described in the first aspect is executed.

In an eighth aspect, an embodiment of the present application provides a communication device, which includes a processor. When the processor executes a computer program in a memory, the method described in the second aspect is executed.

In a ninth aspect, an embodiment of the present application provides a communication device, which includes a processor. When the processor executes a computer program in a memory, the method described in the third aspect is executed.

In a tenth aspect, an embodiment of the present application provides a communication device, which includes a processor and a memory in which a computer program is stored; the processor executes the computer program stored in the memory so that the communication device executes the method described in the first aspect above.

In an eleventh aspect, an embodiment of the present application provides a communication device, which includes a processor and a memory in which a computer program is stored; the processor executes the computer program stored in the memory so that the communication device executes the method described in the second aspect above.

In a twelfth aspect, an embodiment of the present application provides a communication device, which includes a processor and a memory in which a computer program is stored; the processor executes the computer program stored in the memory so that the communication device executes the method described in the third aspect above.

In a thirteenth aspect, an embodiment of the present application provides a communication device, which includes a processor and an interface circuit, wherein the interface circuit is used to receive code instructions and transmit code instructions to the processor, and the processor is used to run the code instructions to enable the device to execute the method described in the first aspect above.

In a fourteenth aspect, an embodiment of the present application provides a communication device, which includes a processor and an interface circuit, wherein the interface circuit is used to receive code instructions and transmit code instructions to the processor, and the processor is used to run the code instructions to enable the device to execute the method described in the second aspect above.

In a fifteenth aspect, an embodiment of the present application provides a communication device, which includes a processor and an interface circuit, wherein the interface circuit is used to receive code instructions and transmit code instructions to the processor, and the processor is used to run the code instructions to enable the device to execute the method described in the third aspect above.

In a sixteenth aspect, an embodiment of the present application provides a communication system. The system includes the communication device described in the fourth aspect, the communication device described in the fifth aspect, and the communication device described in the sixth aspect, or the system includes the communication device described in the seventh aspect, the communication device described in the eighth aspect, and the communication device described in the ninth aspect, or the system includes the communication device described in the tenth aspect, the communication device described in the eleventh aspect, and the communication device described in the twelfth aspect, or the system includes the communication device described in the thirteenth aspect, the communication device described in the fourteenth aspect, and the communication device described in the fifteenth aspect.

In a seventeenth aspect, an embodiment of the present application provides a non-transitory computer-readable storage medium for storing instructions for the above-mentioned terminal device, and when the instructions are executed, the terminal device executes the method described in the first aspect.

In an eighteenth aspect, an embodiment of the present application provides a non-transitory computer-readable storage medium for storing instructions for the above-mentioned network device. When the instructions are executed, the network device executes the method described in the above-mentioned second aspect.

In a nineteenth aspect, an embodiment of the present application provides a non-transitory computer-readable storage medium for storing instructions for the above-mentioned second terminal device. When the instructions are executed, the second terminal device executes the method described in the third aspect.

In a twentieth aspect, the present application also provides a computer program product including a computer program, which, when executed on a computer, enables the computer to execute the method described in the first aspect above.

In a twenty-first aspect, the present application also provides a computer program product including a computer program, which, when executed on a computer, enables the computer to execute the method described in the second aspect above.

In a twenty-second aspect, the present application also provides a computer program product including a computer program, which, when executed on a computer, enables the computer to execute the method described in the third aspect above.

In a twenty-third aspect, the present application provides a chip system, which includes at least one processor and an interface, for supporting a terminal device to implement the functions involved in the first aspect, for example, determining or processing at least one of the data and information involved in the above method. In one possible design, the chip system also includes a memory, which is used to store computer programs and data necessary for the terminal device. The chip system can include a chip, or it can include a chip and other discrete devices.

In a twenty-fourth aspect, the present application provides a chip system, which includes at least one processor and an interface, for supporting a network device to implement the functions involved in the second aspect, for example, determining or processing at least one of the data and information involved in the above method. In one possible design, the chip system also includes a memory, which is used to store computer programs and data necessary for the network device. The chip system can include a chip, or it can include a chip and other discrete devices.

In a twenty-fifth aspect, the present application provides a chip system, which includes at least one processor and an interface, for supporting the second terminal device to implement the functions involved in the third aspect, for example, determining or processing at least one of the data and information involved in the above method. In one possible design, the chip system also includes a memory, which is used to store computer programs and data necessary for the second terminal device. The chip system can include a chip, or it can include a chip and other discrete devices.

In a twenty-sixth aspect, the present application provides a computer program which, when executed on a computer, enables the computer to execute the method described in the first aspect above.

In a twenty-seventh aspect, the present application provides a computer program which, when executed on a computer, enables the computer to execute the method described in the second aspect above.

In a twenty-eighth aspect, the present application provides a computer program which, when executed on a computer, enables the computer to execute the method described in the third aspect above.

In the above embodiments, it may be implemented in whole or in part by software, hardware, firmware, or any combination thereof. When implemented by software, it may be implemented in whole or in part in the form of a computer program product. The computer program product includes one or more computer programs. When the computer program is loaded and executed on a computer, the processes or functions described in accordance with the embodiments of the present disclosure are generated in whole or in part. The computer may be a general-purpose computer, a dedicated computer, a computer network, or other programmable device. The computer program may be stored in a computer-readable storage medium, or been transferred from one computer-readable storage medium to another, for example, the computer program may be transferred from a website, computer, server, or data center to another website, computer, server or data center via wired (such as coaxial cable, optical fiber, digital subscriber line (DSL)) or wireless (such as infrared, wireless, microwave, or the like) means. The computer-readable storage medium may be any available medium that can be accessed by a computer, or a data storage device such as an integrated server, data center, or the like, that includes one or more available media. The available media may be magnetic media (e.g., floppy disks, hard disks, magnetic tapes), optical media (e.g., high-density digital video discs (DVD)), or semiconductor media (e.g., solid state disks, SSD)) or the like.

It is to be understood that in the present disclosure, “plurality” refers to two or more than two, and other quantifiers are similar thereto. “And/or” describes the association relationship of associated objects, indicating that three relationships may exist. For example, A and/or B may represent: A exists alone, A and B exist at the same time, and B exists alone. The character “/” generally indicates that the associated objects before and after are in an “or” relationship. The singular forms “a”, “the” and “the” are also intended to include plural forms, unless the context clearly indicates other meanings.

It is further understood that, although the operations are described in a specific order in the drawings in the embodiments of the present disclosure, it should not be interpreted as requiring the operations to be performed in the specific order shown or in a serial order, or requiring the execution of all the shown operations to obtain the desired results. In certain environments, multitasking and parallel processing may be advantageous.

It should be understood that, although the terms first, second, third, etc. may be used to describe various information in the embodiments of the present application, these information should not be limited to these terms. These terms are only used to distinguish the same type of information from each other. For example, without departing from the scope of the embodiments of the present application, the first information may also be referred to as the second information, and similarly, the second information may also be referred to as the first information. Depending on the context, the words “if” and “in the case” as used herein may be interpreted as “at . . . ” or “when . . . ” or “in response to determination”.

At least one in the present disclosure can also be described as one or more, and the plurality can be two, three, four or more, which is not limited in the present disclosure. In the embodiment of the present disclosure, for one type of technical feature, “first”, “second”, “third”, “A”, “B”, “C” and “D”, or the like are used to distinguish the technical features in the type of technical feature, and the technical features described with “first”, “second”, “third”, “A”, “B”, “C” and “D” are in no order of precedence or order of size.

The corresponding relationships shown in each table in this disclosure can be configured or predefined. The values of the information in each table are only examples and can be configured as other values, which is not limited by this disclosure. When configuring the correspondence between information and each parameter, it is not necessarily required to configure all the correspondences shown in each table. For example, in the table in this disclosure, the corresponding relationships shown in some rows may not be configured. For another example, appropriate deformation adjustments can be made based on the above table, such as splitting, merging, or the like. The names of the parameters shown in the titles of the above tables may also be other names understandable by the communication device, and the values or expressions of the parameters may also be other values or expressions understandable by the communication device. When implementing the above tables, other data structures can also be used, such as arrays, queues, containers, stacks, linear lists, pointers, linked lists, trees, graphs, structures, classes, heaps, hash tables, or the like.

Predefinition in this disclosure may be understood as definition, pre-definition, storage, pre-storage, pre-negotiation, pre-configuration, firming, or pre-burning.

Those of ordinary skill in the art will appreciate that the units and algorithm steps of each example described in conjunction with the embodiments disclosed herein can be implemented with electronic hardware, or a combination of computer software and electronic hardware. Whether these functions are implemented in hardware or software depends on the specific application and design restrictions of the technical solution. Those skilled in the art may implement the described functions using different methods for each specific application, but such implementations should not be considered to be beyond the scope of this disclosure.

Those skilled in the art can clearly understand that for the convenience and simplicity of description, the specific operating processes of the systems, devices and units described above can be referred to the corresponding processes in the foregoing method embodiments, which will not be described again here.

Those skilled in the art will readily appreciate other embodiments of the present disclosure after considering the specification and practicing the application disclosed herein. This application is intended to cover any variations, uses, or adaptations of the present disclosure that follow the general principles of the present disclosure and include common knowledge or customary techniques in the art that are not disclosed in the present disclosure. The specification and examples are intended to be exemplary only, and the true scope and spirit of the present disclosure are indicated by the following claims.

The above are only specific embodiments of the present disclosure, but the protection scope of the present disclosure is not limited thereto. Any changes or substitutions easily conceivable to those skilled in the art within the technical scope disclosed in the present disclosure should be covered by the protection scope of this disclosure. Therefore, the protection scope of the present disclosure should be subject to the protection scope of the claims.

1. A method for sharing a channel occupancy time (COT) of a frame based equipment (FBE), the method being performed by a first terminal device and comprising:
sending indication information of the first terminal device for indicating a fixed frame period (FFP) during which a currently enabled COT is located to a network device, wherein the indication information comprises at least parameter information of the FFP.

2. The method according to claim 1, wherein the indication information further comprises a COT sharing indication, and wherein the COT sharing indication is used to indicate whether to share the currently enabled COT.

3. The method according to claim 2, wherein the parameter information comprises at least one of identification information of the FFP or a sharing parameter of the currently enabled COT, and wherein the sharing parameter comprises at least one of a sharing start position of the COT or a sharing duration of the COT.

4. The method according to claim 1, wherein the sending comprises:
sending the indication information to the network device in an uplink transmission performed within the currently enabled COT.

5. The method according to claim 3, wherein before the sending, the method further comprises:
determining a COT segment remaining at an end of an uplink transmission of the first terminal device as a shared COT segment; and
determining the sharing parameter based on format configuration information of a transmission time domain unit in the shared COT segment.

6. (canceled)

7. The method according to claim 5, wherein after determining the sharing parameter of the COT, the method further comprises:
generating a sharing configuration table based on the COT sharing indication and the identification information of the FFP, wherein the sharing configuration table is used as the indication information.

8. A method for sharing a channel occupancy time (COT) of a frame based equipment (FBE), the method being performed by a network device and comprising:
receiving indication information sent by a first terminal device, wherein the indication information at least comprises parameter information of a fixed frame period (FFP) during which a currently enabled COT of the first terminal device is located; and
sending the indication information to at least one second terminal device.

9. The method according to claim 8, wherein the indication information further comprises a COT sharing indication, and wherein the COT sharing indication is used to indicate whether to share the currently enabled COT, and the sending comprises:
determining, according to the COT sharing indication, that the currently enabled COT is allowed to be shared; and
sending the indication information to the at least one second terminal device.

10. The method according to claim 8, wherein the parameter information comprises at least one of identification information of the FFP or a sharing parameter of the currently enabled COT, and wherein the sharing parameter comprises at least one of a sharing start position of the COT or a sharing duration of the COT.

11. (canceled)

12. The method according to claim 8, wherein the sending comprises:
scheduling the second terminal device based on downlink control information (DCI); and
sending the indication information to the at least one second terminal device through the DCI.

13. The method according to claim 8, further comprising at least one of:
performing downlink transmission on a shared COT segment within the currently enabled COT in response to the currently enabled COT being allowed to be shared; or
sending the indication information to the at least one second terminal device through the downlink transmission.

14. The method according to claim 13, wherein the sending comprises:
determining occupancy information of the shared COT segment by the downlink transmission of the network device;
updating the parameter information of the FFP in the indication information according to the occupancy information; and
sending the updated indication information to the at least one second terminal device.

15. A method for sharing a channel occupancy time (COT) of a frame based equipment (FBE), the method being performed by a second terminal device and comprising:
obtaining indication information sent by a network device, wherein the indication information at least includes parameter information of a fixed frame period (FFP) during which a currently enabled COT of a first terminal device is located; and
performing uplink transmission within a shared COT segment of the currently enabled COT based on the indication information.

16. The method according to claim 15, wherein the parameter information comprises at least one of identification information of the FFP or a sharing parameter of the currently enabled COT, wherein the sharing parameter comprises at least one a sharing start position of the COT or a sharing duration of the COT.

17. (canceled)

18. The method according to claim 15, wherein the obtaining comprises at least one of:
receiving downlink control information (DCI) for scheduling the second terminal device, wherein the DCI carries the indication information; or
detecting a downlink transmission sent by the network device, wherein the downlink transmission carriers the indication information.

19. (canceled)

20. The method according to claim 16, wherein the performing comprises:
determining the FFP during which the shared COT fragment is located according to the identification information of the FFP;
determining a transmission duration of the uplink transmission; and
performing the uplink transmission within the shared COT segment based on the transmission duration and the sharing parameter.

21. (canceled)

22. The method according to claim 20, wherein the performing comprises at least one of:
in response to the transmission duration being less than or equal to a sharing duration of the COT in the sharing parameter, performing the uplink transmission within the shared COT segment starting from a shared position of the COT in the sharing parameter;
in response to the transmission duration being greater than the sharing duration of the COT in the sharing parameter, performing the uplink transmission within the shared COT segment starting from the shared position of the COT in the sharing parameter, and interrupting the uplink transmission when the sharing duration of the COT is reached; or
in response to the transmission duration being greater than the sharing duration of the COT, determining not to share the shared COT segment.

23-26. (canceled)

27. A communication device, comprising a processor and a memory, wherein a computer program is stored in the memory, and when executed by the processor, causes the device to perform the method according to claim 1.

28. A communication device, comprising a processor and a memory, wherein a computer program is stored in the memory, and when executed by the processor, causes the device to perform the method according to claim 8.

29. A communication device, comprising a processor and a memory, wherein a computer program is stored in the memory, and when executed by the processor, causes the device to perform the method according to claim 15.

30-35. (canceled)
